(19) United States
(12) Patent Application Publication
(10) Pub. No.: US 2026/0021465 A1
(43) Pub. Date: Jan. 22, 2026

(54) STRUCTURED PACKING

(71) Applicant: Koch-Glitsch, LP, Wichita, KS (US)

(72) Inventors: Scott Clifford, Wichita, KS (US); Izak Nieuwoudt, Wichita, KS (US)

(21) Appl. No.: 18/994,629

(22) PCT Filed: Jul. 25, 2023
(86) PCT No.: PCT/IB2023/057539

§ 371 Date: Jan. 15, 2025

Related U.S. Application Data
(60) Provisional application No. 63/394,976, filed on Aug. 4, 2022.

(51) Int. Cl. B01J 19/32

(52) U.S. Cl. CPC B01J 19/32; B01J 2219/3221; B01J 2219/32213; B01J 2219/32227; B01J 2219/32251

(57) ABSTRACT

A corrugated structured packing sheet has the combination of corrugations that include a curve formed in the geometry of the corrugations in the lower edge region of the structured packing sheet and a surface texturing on opposite faces of the structured packing sheet that are in the form of a grid of indented and raised structures. Each indented structure is separated from some or all of adjacent ones of the indented structures by the raised structures. The raised structures form rows of peaks and interconnecting saddles. Microchannels extend along adjacent ones of the indented structures and the interconnecting saddles. The surface texturing caused an unexpected performance improvement when used with the curved geometry of the corrugations in the lower edge region.

### RELATED APPLICATION

This application claims priority to U.S. Provisional Patent Application No. 63/394,976 filed Aug. 4, 2022, with the above-identified application being incorporated by reference herein in its entirety.

The present invention relates generally to mass transfer columns and, more particularly, to structured packing used to facilitate mass and heat transfer between fluids in such columns.

Mass transfer columns are configured to contact at least two fluid streams in order to provide product streams of specific composition and/or temperature. The term “mass transfer column” as used herein is intended to encompass columns in which mass and/or heat transfer is the primary objective. Some mass transfer columns, such as those utilized in multicomponent distillation and absorption applications, contact a gas-phase stream with a liquid-phase stream, while others, such as extraction columns, may be designed to facilitate contact between two liquid phases of different densities. Oftentimes, mass transfer columns are configured to contact an ascending vapor or liquid stream with a descending liquid stream, usually along multiple mass transfer surfaces disposed within the column. Commonly, these transfer surfaces are defined by structures placed in the interior volume of the column that are configured to facilitate intimate contact between the two fluid phases. As a result of these mass transfer surfaces, the rate and/or degree of mass and heat transferred between the two phases is enhanced.

Structured packing is one type of a mass transfer surface that is commonly used to enhance heat and/or mass transfer performance within a column. Many different types of structured packing exist, and most include a plurality of corrugated structured packing sheets that are positioned in an upright, parallel relationship and are joined together to form a structured packing module with fluid passages formed along the crisscrossing corrugations of adjacent sheets. The structured packing module may by itself form a structured packing layer that fills a horizontal internal cross section of the mass transfer column, or the packing module may be in the form of individual bricks that are positioned end-to-end and side-by-side to form the structured packing layer. Multiple structured packing layers are normally stacked on top of each other with the orientation of the sheets in one layer rotated with respect to the sheets in adjacent structured packing layers.

It is generally desirable to maximize heat and/or mass transfer between the vapor and liquid phases as they flow through the structured packing layer. This is typically achieved by increasing the specific surface area available for mass and energy transfer. However, fluids passing through a structured packing layer having a higher specific surface area will normally experience a higher pressure drop, which is undesirable from an operational standpoint.

One approach to improving heat and/or mass transfer performance of the structured packing without increasing the specific surface area of the structured packing layer is to use various types of surface texturing on the structured packing sheets. The surface texturing facilitates the spreading of the liquid phase across the surface of the structured packing sheets, which then leads to increased heat and/or mass transfer between the liquid and vapor phases. A single type of surface texturing is normally applied over the entire surface area of the structured packing sheet.

One type of known surface texturing uses grooves that extend in a lateral direction that is parallel to a top and a bottom edge of the corrugated structured packing sheet. A potential drawback to this type of surface texturing is that if the structured packing sheet is not level, the grooves will be inclined from the horizontal and the liquid that travels along the grooves will preferentially flow in one direction, leading to maldistribution of the liquid and a reduction in the mass transfer efficiency.

Another type of surface texturing that normally has a higher mass transfer efficiency than the groove-type surface texturing comprises a uniform grid of indented and raised structures in which each indented structure is separated from an adjacent indented structure by a raised structure. The indented structures on one face of the structured packing sheet form the raised structures on the opposite face of the structured packing sheet and vice versa.

The raised structures that surround the indented structures form rows comprising peaks and interconnecting saddles, with the saddles and indented structures forming rows of microchannels along which liquid preferentially flows. The rows and microchannels are inclined and intersect the top and bottom edges of the structured packing sheet at an angle. It has been found that the spreading pattern of the liquid may be influenced by these microchannels.

The capacity of a structured packing layer may also be limited by the behavior of the vapor and liquid phases as they change their direction of flow at the interface between vertically adjacent structured packing layers. As a result of this change in flow direction, liquid may tend to build up at the interfaces and cause a reduction in capacity and performance, particularly at higher liquid loads.

One approach to increasing the capacity of the structured packing layer and/or reducing the pressure drop at the interfaces involves modifications to the geometry of the corrugations at the bottom of the structured packing layer. In one such modification, a curve is formed in the geometry of the corrugations in the bottom portion and, optionally, the upper portion of the structured packing layer such that the angle of the corrugations in relation to the vertical axis of the mass transfer column gradually increases from the angle present in the bulk region of the structured packing layer to a larger angle at the lower edge and, optionally, at the upper edge of the structured packing layer. This curved geometry in the corrugations reduces the premature build-up of liquid at the interfaces of the structured packing layers and reduces the pressure drop that would otherwise be present at the interfaces if the curved geometry is not used.

### SUMMARY

In one aspect, the present invention is directed to a structured packing module comprising a plurality of structured packing sheets positioned in an upright, parallel relationship to each other and a surface texturing on the structured packing sheets. Each structured packing sheet comprises: opposite faces; an upper edge and a lower edge; a lower edge region that is adjacent the lower edge; a bulk region above the lower edge region; and corrugations formed of alternating peaks and valleys that are interconnected by corrugation sidewalls and extend in an inclined direction that forms an inclination angle in relation to the upper edge and/or the lower edge of the structured packing sheet. The structured packing sheets are constructed and arranged such that the corrugations of adjacent ones of the structured packing sheets cross at an angle to each other. Each structured packing sheet further includes a curve formed in the geometry of the corrugations in the lower edge region such that an inclination angle of the corrugations in relation to the lower edge gradually increases from the bulk region through the lower edge region. The surface texturing on the structured packing sheets comprises a grid of indented and raised structures in the bulk region with each indented structure being separated from some or all of adjacent ones of the indented structures by the raised structures, the raised structures forming rows of peaks and interconnecting saddles; and microchannels that extend along adjacent ones of the indented structures and the interconnecting saddles that are positioned between each of the adjacent ones of the indented structures.

In another aspect, the present invention is directed to a structured packing sheet comprising: opposite faces; an upper edge and a lower edge; a lower edge region that is adjacent the lower edge; a bulk region above the lower edge region; a plurality of apertures that extend through the structured packing sheet; corrugations formed of alternating peaks and valleys that are interconnected by corrugation sidewalls and extend in an inclined direction that forms an inclination angle in relation to the upper edge and/or the lower edge of the structured packing sheet; a curve formed in the geometry of the corrugations in the lower edge region such that an inclination angle of the corrugations in relation to the lower edge gradually increases from the bulk region through the lower edge region; and surface texturing on the opposite faces. The surface texturing comprises a grid of indented and raised structures with each indented structure being separated from some or all of adjacent ones of the indented structures by the raised structures, the raised structures forming rows of peaks and interconnecting saddles; and microchannels that extend along adjacent ones of the indented structures and the interconnecting saddles that are positioned between each of the adjacent ones of the indented structures.

In a further aspect, the present invention is directed to a structured packing sheet comprising: opposite faces; an upper edge and a lower edge; a lower edge region that is adjacent the lower edge; a bulk region above the lower edge region; a plurality of apertures that extend through the structured packing sheet; corrugations formed of alternating peaks and valleys that are interconnected by corrugation sidewalls and extend in an inclined direction that forms an inclination angle in relation to the upper edge and/or the lower edge of the structured packing sheet; a curve formed in the geometry of the corrugations in the lower edge region such that an inclination angle of the corrugations in relation to the lower edge gradually increases from the bulk region through the lower edge region; and surface texturing on the opposite faces. The surface texturing comprises a grid of indented and raised structures with each indented structure being separated from some or all of adjacent ones of the indented structures by the raised structures, the raised structures forming rows of peaks and interconnecting saddles; and microchannels that extend along adjacent ones of the indented structures and the interconnecting saddles that are positioned between each of the adjacent ones of the indented structures.

### BRIEF DESCRIPTION OF THE DRAWINGS

In the accompanying drawings that form part of the specification and in which like numbers are used to indicate like components in the various views:

FIG. 1 is a fragmentary side elevation view of a mass transfer column with the column shell taken in vertical section to show four structured packing layers of the present invention positioned in a stacked arrangement within the mass transfer column;

FIG. 2 is a front perspective view of a corrugated structured packing sheet of the present invention that forms a portion of a structured packing module and has apertures and an embodiment of a surface texturing that comprises a grid of indented and raised structures, wherein the surface texturing is representationally shown covering only certain portions of the sheet for ease of viewing and understanding, but which may, in fact, cover the entire sheet;

FIG. 3 is an enlarged fragmentary view of a structured packing sheet having one embodiment of a surface texturing that comprises a grid of indented and raised structures in the form of cone-shaped peaks and valleys;

FIG. 3a is a cross-sectional view along line 3a-3a of FIG. 3;

FIG. 3b is a cross-sectional view along line 3b-3b of FIG. 3;

FIG. 4 is an enlarged fragmentary view of a structured packing sheet having another embodiment of surface texturing that comprises a grid of indented and raised structures in the form of elongated ridge-shaped peaks and valleys;

FIG. 4a is a cross-sectional view along line 4a-4a of FIG. 4;

FIG. 4b is a cross-section view along line 4b-4b of FIG. 4;

FIG. 5 is an enlarged fragmentary view of a structured packing sheet having yet another embodiment of surface texturing that comprises a grid of indented and raised structures in the form of cone-shaped peaks and valleys with higher saddles between rows of peaks and lower saddles between columns of peaks;

FIG. 5a is a cross-sectional view along line 5a-5a of FIG. 5;

FIG. 5b is a cross-section view along line 5b-5b of FIG. 5; and

FIG. 6 is a front perspective view of another embodiment of a corrugated structured packing sheet of the present invention and is similar to the structured packing sheet shown in FIG. 2 except it has curved corrugations at an upper edge region in addition to the curved corrugations at a lower edge region as shown in FIG. 2.

### DETAILED DESCRIPTION

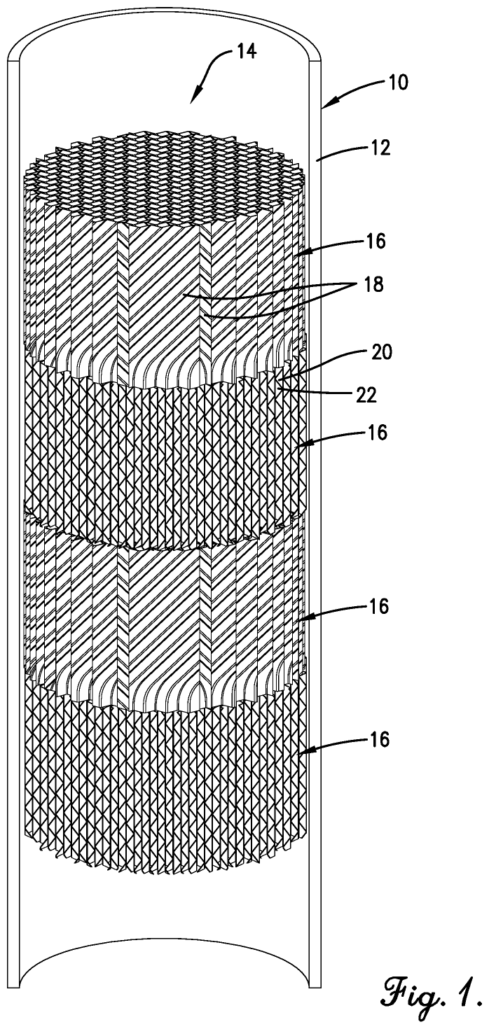

Turning now to the drawings in greater detail and initially to FIG. 1, a mass transfer column suitable for use in mass transfer and heat exchange processes is represented generally by the numeral 10. The mass transfer column 10 includes an upright, external shell 12 that is generally cylindrical in configuration, although other configurations, including polygonal, are possible and are within the scope of the present invention. The shell 12 is of any suitable diameter and height and is constructed from one or more rigid materials that are desirably inert to, or are otherwise compatible with, the fluids and conditions present during operation of the mass transfer column 10.

The shell 12 of the mass transfer column 10 defines an open internal region 14 in which the desired mass transfer and/or heat exchange between the fluid streams occurs. Normally, the fluid streams comprise one or more ascending vapor streams and one or more descending liquid streams. Alternatively, the fluid streams may comprise both ascending and descending liquid streams. The fluid streams are directed into the mass transfer column 10 through any number of feed lines (not shown) positioned at appropriate locations along the height of the mass transfer column 10. One or more vapor streams may also be generated within the mass transfer column 10 rather than being introduced into the column 10 through the feed lines.

The mass transfer column 10 will also typically include an overhead line (not shown) for removing a vapor product or byproduct and a bottom stream takeoff line (not shown) for removing a liquid product or byproduct from the mass transfer column 10. Other column components that are typically present, such as feed points, sidedraws, reflux stream lines, reboilers, condensers, vapor horns, liquid distributors, and the like, are not illustrated in the drawings because an illustration of these components is not believed to be necessary for an understanding of the present invention.

One or more structured packing layers 16 comprising multiple individual structured packing sheets 18 are positioned within the open internal region 14 and extend across the horizontal, internal cross section of the mass transfer column 10. In the illustrated embodiment, four structured packing layers 16 are placed in vertically stacked relationship to each other, but it is to be understood that more or fewer structured packing layers 16 may be provided.

In one embodiment, each one of the structured packing layers 16 is formed as a single structured packing module that extends completely across the horizontal, internal cross section of the column 10. In another embodiment, each structured packing layer 16 is formed as a plurality of individual structured packing modules (not shown), referred to as bricks, that are positioned in end-to-end and side-to-side relationship to fill the horizontal, internal cross section of the mass transfer column 10.

The structured packing layers 16 are each suitably supported within the mass transfer column 10, such as on a support ring (not shown) that is fixed to the shell 12, on an underlying one of the structured packing layers 16, or by a grid or other suitable support structure. In one embodiment, the lowermost structured packing layer 16 is supported on a support structure and the overlying structured packing layers 16 are stacked one on top of the other and are supported by the lowermost structured packing layer 16.

Successive structured packing layers 16 are typically rotated relative to each other so that the individual structured packing sheets 18 in one of the packing layers 16 are positioned in vertical planes that extend at an angle with respect to the vertical planes defined by the individual structured packing sheets 18 in the adjacent one(s) of the packing layers 16. This rotation angle is typically 45 or 90 degrees but can be other angles if desired. The height of each structured packing element 16 may be varied, depending on the particular application. In one embodiment, the height is within the range of from about 50 to about 400 mm.

The structured packing sheets 18 in each structured packing layer 16 are positioned in an upright, parallel relationship to each other. Each of the structured packing sheets 18 is constructed from a suitably rigid material, such as any of various metals, plastics, or ceramics, having sufficient strength and thickness to withstand the processing conditions experienced within the mass transfer column 10.

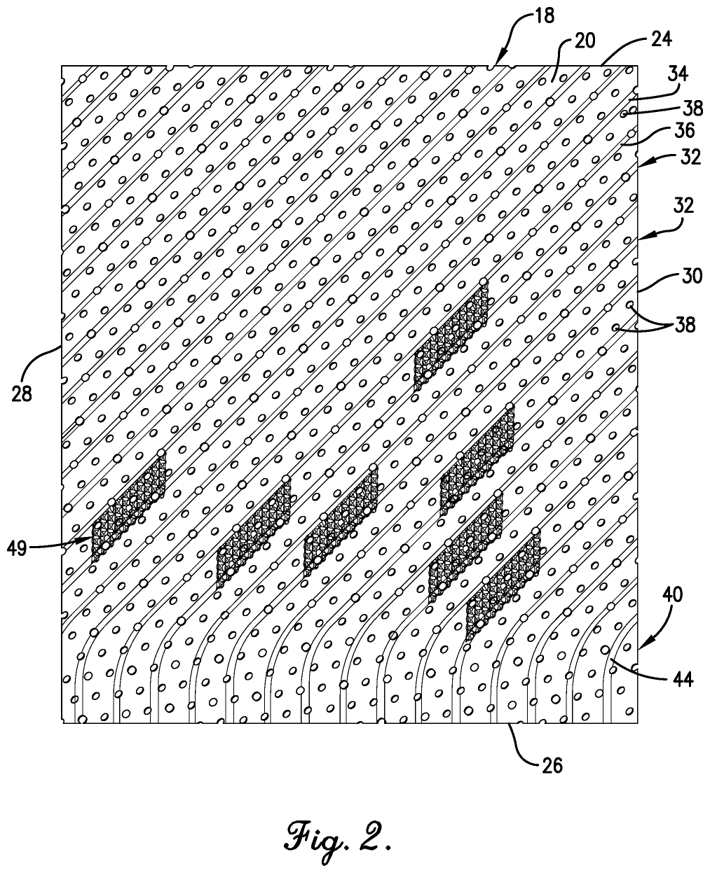

Turning additionally to FIG. 2, each of the structured packing sheets 18 presents opposite front and back faces 20 and 22, opposite upper and lower edges 24 and 26, and opposite side edges 28 and 30. Each of the structured packing sheets 18 has a plurality of parallel corrugations 32 that extend along a portion, or all, of the associated structured packing sheet 18. The corrugations 32 are formed of alternating peaks 34 and valleys 36 and corrugation sidewalls 38 that extend between adjacent ones of the peaks 34 and valleys 36. The peaks 34 on the front face 20 of each structured packing sheet 18 form valleys 36 on the opposite or back face 22 of the structured packing sheet 18. Likewise, the valleys 36 on the front face 20 of each structured packing sheet 18 form the peaks 34 on the back face 22 of the structured packing sheet 18.

In the illustrated embodiments, the corrugations 32 of each one of the structured packing sheets 18 extend along the entire height and width of the structured packing sheet 18 and are generally of a triangular or sinusoidal cross section. Adjacent ones of the structured packing sheets 18 in each structured packing layer 16 are positioned in facing relationship so that the front face 20 of one of the structured packing sheets 18 faces the back face 22 of the adjacent structured packing sheet 18.

As described in greater detail below, in one embodiment, such as shown in FIG. 2, the geometry of the corrugations 32 in a lower edge region 40 that is adjacent the lower edge 26 of each structured packing sheet 18 differs from the geometry of the corrugations 32 in an adjacent bulk region that forms the remainder of the structured packing sheet 18. The lower edge region 40 is some embodiments may span 5 to 30 percent, 5 to 25 percent, or 5 to 20 percent of the vertical distance from the lower edge 26 to the upper edge 24 of each structured packing sheet 18. In other embodiments, the lower edge region 40 may span 20 to 60 percent, 20 to 50 percent, 25 to 45 percent, or 30 to 40 percent of the distance from the lower edge 26 to the upper edge 24 of each structured packing sheet 18.

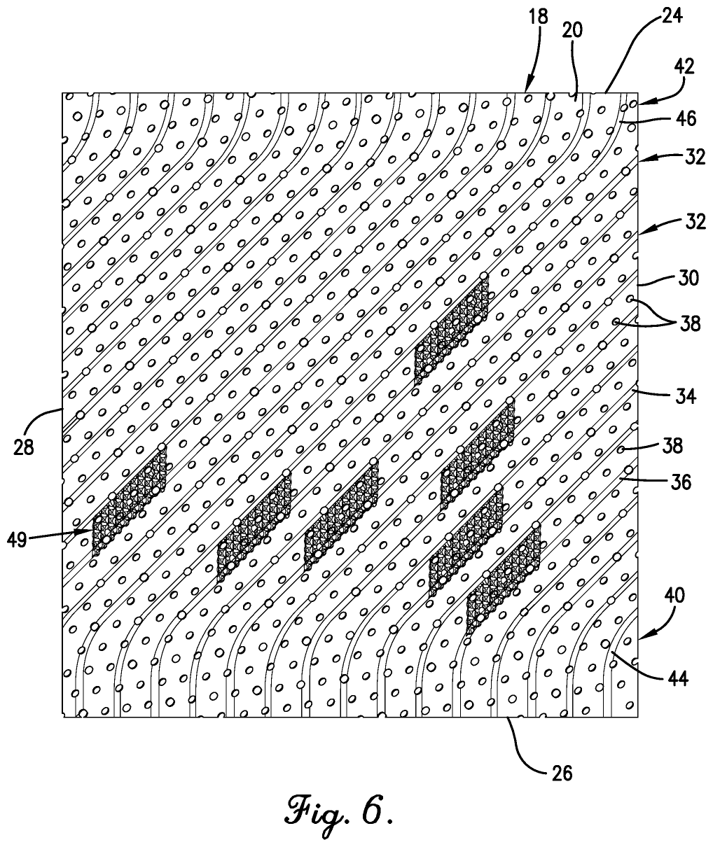

In other embodiments, such as shown in FIG. 6, the geometries of the corrugations 32 in both the lower edge region 40 and an upper edge region 42 that is adjacent the upper edge 24 of the structured packing sheet 18 differ from the geometry of the corrugations 32 in the remaining bulk region. In the illustrated embodiment, the lower edge region 40 spans a greater vertical distance than the upper edge region 42. For example, the lower edge region 40 may span 5 to 35 percent, 5 to 25 percent, 5 to 20 percent, or 30 to 35 percent and the upper edge region 42 may span 5 to 30 percent, 5 to 20 percent, 5 to 10 percent, or 20 to 25 percent of the distance from the lower edge 26 to the upper edge 24 of each structured packing sheet 18. In other embodiments, the lower edge region 40 and the upper edge region 42 may span the same distance. For example, the lower edge region 40 and the upper edge region 42 may each span 5 to 35 percent, 5 to 25 percent, 5 to 20 percent, or 30 to 35 percent of the vertical distance from the lower edge 26 to the upper edge 24 of each structured packing sheet 18. In other examples,

The adjacent structured packing sheets 18 are further arranged so that the corrugations 32 in each one of the structured packing sheets 18 extends in a crisscrossing, or cross-corrugated, manner to those corrugations 32 in the adjacent one(s) of the structured packing sheets 18. As a result of this arrangement, the corrugations 32 in each one of the structured packing sheets 18 cross at an angle to the corrugations 32 of each adjacent one of the structured packing sheets 18 in the bulk region and in all or a portion of the lower edge region 40. In one embodiment, all of the peaks 34 of the corrugations 32 on the front face 20 of each one of the structured packing sheets 18 are in contact with the peaks 34 of the corrugations 32 on the back face 22 of the adjacent one of the structured packing sheets 18 in the bulk region and in all or a portion of the lower edge region 40. In other embodiments, some of the peaks 34 of the corrugations 32 on the front face 20 of the structured packing sheets 18 are not in contact with the peaks 34 on the back face of the adjacent one of the structured packing sheets 18.

The peaks 34 and valleys 36 of the corrugations 22 are generally formed as curved arcs that may be defined by an apex radius. In general, as the apex radius increases, the arc of curvature of the peaks 34 and valleys 36 increases and the length of the corrugation sidewalls 38 between the peaks 34 and valleys 36 conversely decreases, for a given specific surface area. The two corrugation sidewalls 38 of each corrugation 32 form an apex angle. Apex radius, apex angle, packing crimp height, and peak 34 to peak 34 length are interrelated, and may be varied to achieve a desired geometry and specific surface area. In general, as crimp height is lowered the number of structured packing sheets 18 contained in each structured packing layer 16 (or module), and the associated specific surface area, increases.

The corrugations 32 are inclined in a direction that forms an acute or, in an area near the lower edge 26, a perpendicular inclination angle in relation to the upper and/or lower edges 24 and 26 of the structured packing sheet 18. The inclination angle may be selected for the requirements of particular applications in which the structured packing sheets 18 are to be used. In one embodiment, the inclination angle in the bulk region may be in the range of 25 to 75 degrees. Specific examples of inclination angles are approximately 30 degrees, approximately 45 degrees, and approximately 60 degrees. Because the upper and lower edges 24 and 26 of the structured packing sheets 18 are positioned perpendicularly to a vertical axis of the mass transfer column 10, the corrugations 32 are also inclined in relation to the vertical axis of the mass transfer column 10. At each location on the structured packing sheet 18, the inclination angle of the corrugations 32 in relation to the upper and/or lower edges 24 and 26 of the structured packing sheet 18 and the acute angle at which the corrugations 32 are inclined in relation to the vertical axis of the mass transfer column 10 are complementary angles.

The geometry of the corrugations 32 in the lower edge region 40 adjacent the lower edge 26 of the structured packing sheet 18 is modified in a manner to increase the capacity of the structured packing layer 16 and/or to reduce the pressure drop as the fluid streams pass through the transition zones at the interfaces between vertically adjacent structured packing layers 16. In one embodiment, such as shown in FIG. 2, a curve 44 is formed in the geometry of the corrugations 32 in the lower edge region 40 such that an inclination angle of the corrugations 32 in relation to the lower edge 26 of the structure packing sheets 18 gradually increases from the bulk region through the lower edge region 40 of the structured packing sheet 18. The inclination angle of the corrugations 32 increases to an inclination angle in the range of 65 to 90 degrees, 75 to 90 degrees, or 85 to 90 degrees at the lower edge 26 of the structured packing sheet 18.

Similarly, as shown in FIG. 6, a curve 46 may also be formed in the geometry of the corrugations 32 in the upper edge region 42 of the structured packing sheets 18. The curve 46 in the upper edge region 42 is formed in a similar manner from the curve 44 in the lower edge region 40.

The curve 44 in the geometry of the corrugations 32 in the lower edge region 40 and, if present, the curve 46 in the geometry in the corrugations 32 in the upper edge region 42 provide a smooth change in the direction of the ascending vapor flow as it transitions between adjacent structured packing layers 16 and enters and exits the bulk region of the structured packing sheets 18. This smooth transition of the vapor flow direction reduces the premature build-up of liquid at the interfaces of the structured packing layers 16 and reduces the pressure drop that would otherwise be present at the interfaces if the curved geometry is not used.

Some or all of the structured packing sheets 18 may be provided with a plurality of apertures 48 that extend through the structured packing sheet 18 for facilitating vapor and liquid distribution within the structured packing layer 16. Each aperture 40 provides an open area for permitting the passage of fluid through the associated packing sheet 18. The apertures 40 are normally uniformly distributed on the structured packing sheets 18. In one embodiment, the apertures 40 are provided on each of the structured packing sheets 18 in each structured packing layer 16.

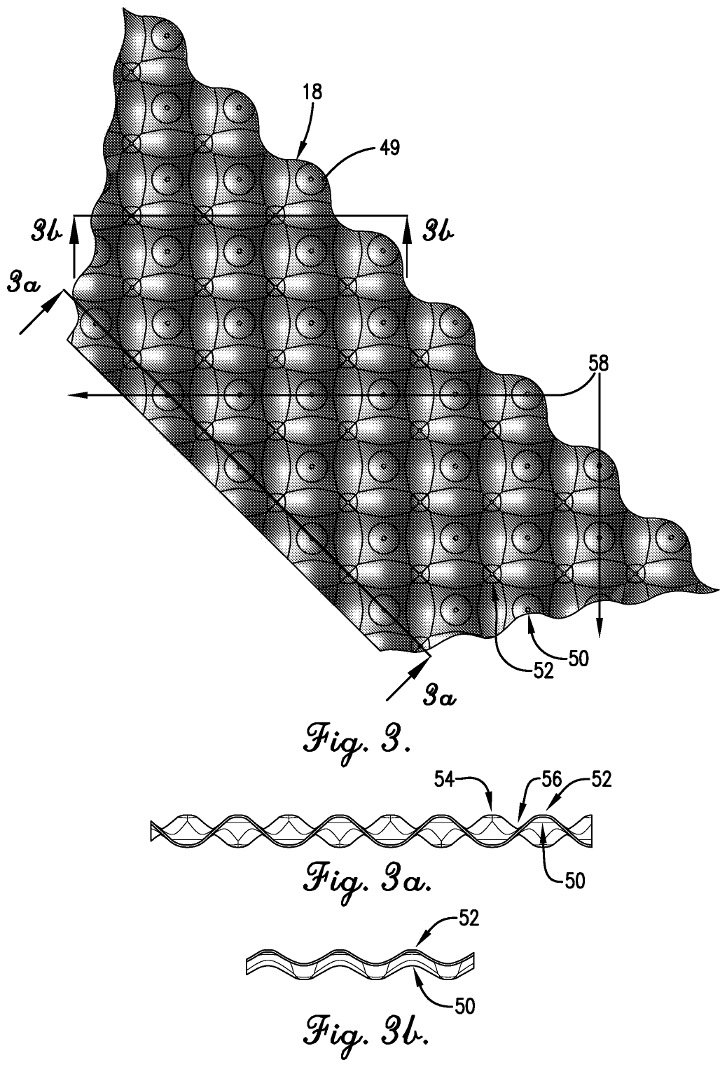

The front and/or back faces 20 and 22 of the structured packing sheets 18 contain one or more different types of surface texturing 49 to facilitate spreading and thereby maximize contact between the ascending and descending fluid streams. In one embodiment as shown in FIG. 3, the surface texturing 49 comprises a grid of indented structures 50 and raised structures 52 on the front and back faces 20 and 22 of the structured packing sheets 18. Only a few representative areas of the grid of indented and raised structures 50 and 52 are shown in FIG. 3 in order to allow the corrugations 32 to be readily seen, but it is to be understood that the grid may cover the entire surface area of the structured packing sheet 18 or sufficient portions thereof to achieve the desired mass transfer efficiency. In one embodiment the grid extends between the upper and lower edges 24 and 26 and between the side edges 28 and 30 so that it covers the entire surface area of the structured packing sheet 18. In another embodiment, the grid covers 70 to 95 percent of a total surface area of each structured packing sheet 18.

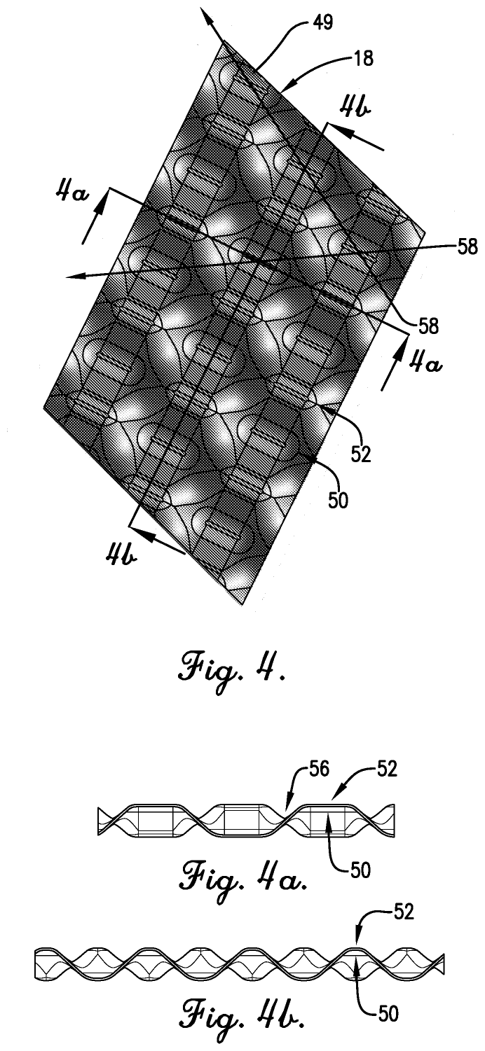

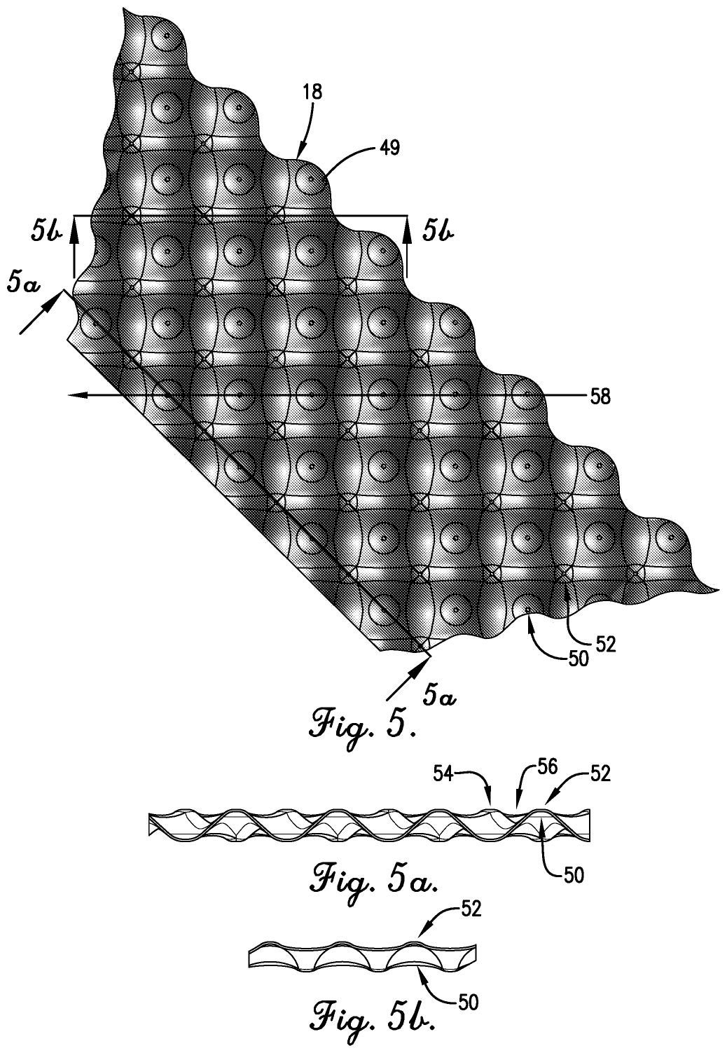

Each indented structure 50 is separated from some or all of the adjacent ones of the indented structures 50 by the raised structures 52. The indented structures 50 are arranged in parallel rows and may be positioned in a square, diamond, triangular or other pattern. The raised structures 52 comprise peaks 54 and interconnecting saddles 56. The peaks 54 may be generally cone-shaped as shown in FIGS. 3, 3a, and 3b and FIGS. 5, 5a, and 5b or they may be elongated to form ridge shapes as shown in FIGS. 4, 4a, 4b. Other shapes and/or configurations are possible and are within the scope of the invention. Normally, at least some portions of the raised structures 52 on the front face 20 are formed by at least some portions of the indented structures 50 on the back face 22, and vice versa. Thus, each of the cone-shaped peaks 54 may be formed by the cone-shaped terminus of one of the indented structures 50 on the opposite face 20 or 22 of the structured packing sheet 18. Likewise, each of the ridge-shaped peaks 54 may be formed by the ridge-shaped terminus of one of the indented structures 50 on the opposite face 20 or 22 of the structured packing sheet 18.

The surface texturing 49 includes microchannels designated by the arrows 58 that extend along adjacent ones of the indented structures 50 and the interconnecting saddles 56 of the raised structures 52 that are positioned between adjacent ones of the indented structures 50. These microchannels 58 may intersect or extend parallel or largely parallel to the corrugation valleys 36 to facilitate the spreading of the liquid across the front and back faces 20 and 22 of the structured packing sheets 18. The orientation of the microchannels 58 to the upper and/or lower edges 24 and 26 of the structured packing sheet 18, and thus the orientation of the microchannels 58 relative to the corrugation valleys 36, is selected to optimize the liquid spreading on the front and back faces 20 and 22.

In one embodiment, some of the microchannels 58 extend in parallel relationship to the corrugation valleys 26. For example, one-third or one-half of the microchannels 58 may extend in parallel relationship to the corrugation valleys 26. In other embodiments, the microchannels 58 intersect the corrugation valleys 36 at an angle in the range of 20 to 75 degrees, where the intersection angle is understood to be the smallest of the possible intersection angles formed between the corrugation valleys 36 and the microchannels 52. In some embodiments, the angle may be in the range of 25 to 70 degrees or 30 to 65 degrees.

Two of the microchannels 58 extend in crossing relation to each other at each indented structure 50 at a crossing angle. The crossing angle in one embodiment may be in the range of 50 to 140 degrees. In other embodiments, the crossing angle may be in the range of 70 to 130 degrees or 85 to 95 degrees. The microchannels 58 may extend linearly as shown in FIG. 3, they may extend in a zigzag fashion as shown in FIG. 4, or they may extend in other fashions as shown in FIG. 5. For example, in the embodiment of FIG. 6, the interconnecting saddles 56 of the raised structures 52 are higher between rows of peaks 54, which forms more of a barrier to fluid flow, and lower between columns of peaks 54, which forms less of a barrier to fluid flow, so that more fluid flows in the microchannels 58 between rows of peaks 54.

Comparative testing was conducted using structured packing layers having two types of corrugations in the structured packing sheets and two types of surface texturing on the structured packing sheets. In one set of tests, a surface texturing used commercially on MONTZ-PAK™ Type B1 structured packing sheets was applied to a straight corrugation structured packing sheet and was tested against the surface texturing 49 described above that was applied to the same type of straight structured packing sheet.

In another set of tests, the surface texturing used commercially on the MONTZ-PAK™ Type B1 structured packing sheets was applied to the structured packing sheet 18 having the curve 44 in the lower region 40 and was tested against the surface texturing 49 described above that was applied to the same type of corrugation structured packing sheet 18 having the curve 44 in the lower edge region 40. In general, the surface texturing used commercially on the MONTZ-PAK™ Type B1 structured packing sheets has a triangular pitch pattern and has finer, more densely packed indented and raised structures than the surface texturing 49 described above.

Prior to conducting the testing, the expectation was that the influence of the surface texturing on the performance of the structured packing layer would be independent of the geometry of the corrugations in the structured packing sheets. In other words, the performance of the surface texturing used commercially on the MONTZ-PAK™ Type B1 structured packing sheets in comparison to the surface texturing 49 on the straight corrugation structured packing sheet was expected to carry forward to the structured packing sheet having the curve 44 in the corrugations 32.

Surprisingly, that expectation was not borne out by the comparative testing data. Instead, the data showed that the surface texturing 49 when used in combination with the curve 44 in the corrugation 22 performed unexpectedly better than was predicted based on the comparative performance of the two surface textures when used with the straight corrugation geometry. The comparative testing data thus demonstrates that the surface texturing 49 performs differently depending on the geometry of the corrugations on the structured packing sheet, with improved synergistic performance achieved by the combination of the surface texturing 49 and the corrugation structured packing sheet 18 having the curve 44 in the lower edge region 40.

This unexpected performance improvement can be seen in the normalized, comparative testing data presented in the following tables, where the straight corrugation structured packing sheets were the KOCH-GLITSCH™ FLEXIPAC® 250Y structured packing sheets, the curved corrugation structured packing sheets 18 had the curve 44 only in the lower edge region 40 and had the corrugation structure found in the commercially available MONTZ-PAK™ B1-250MN structured packing, the MONTZ™ surface texturing was the surface texturing used commercially on the MONTZ-PAK™ Type B1 structured packing sheets, the KOCH-GLITSCH™ surface texturing was the surface texturing 49 described above and generally illustrated in FIGS. 3, 3a and 3b and used commercially on the KOCH-GLITSCH™ FLEXIPAC® 250Y structured packing sheets.

In the comparative test results depicted in Table 1, the performance of the structured packing layer with the MONTZ™ surface texturing was better than the performance of the structured packing layer with the KOCH-GLITSCH™ surface texturing at six of the eleven flow rates and was the same at two of the eleven flow rates. The expectation was that this comparative performance between two surface textures would also be seen when testing was conducted using structured packing layers having the curve 44 in the lower edge region 40. In other words, the structured packing layer with the MONTZ™ surface texturing was expected to perform better than the structured packing layer with the KOCH-GLITSCH™ surface texturing when the geometry of the corrugations was changed in the lower edge region.

Instead, as unexpectantly shown in Table 2, the structured packing layer with the KOCH-GLITSCH™ surface texturing performed better than the structured packing layer with the MONTZ™ surface texturing at eight of the eleven flow rates when the curve 44 was added to the corrugations 22 in the lower edge region 40 and was the same at two of the eleven flow rates. This performance improvement suggests that some type of synergistic interaction occurs when the surface texturing 49 is used in combination with the curve 44 in the lower edge region 40 of the structured packing sheets 18.

TABLE 1

| | | Straight Corrugation | |
|---|---|---|---|
| | | FLEXIPAC ® 250Y | FLEXIPAC ® 250Y |
| | | Surface Texturing: | |
| | | MONTZ ™ | KOCH-GLITSC ™ |
| Pressure | Fs | DP/TS | DP/TS |
| mmHg | ft/s.(lb/ft³)^{1/2} | mmHg | mmHg |
| 75 | 1 | 1.00 | 1.44 |
| | 1.5 | 1.00 | 1.13 |
| | 2 | 1.00 | 1.14 |
| | 2.5 | 1.00 | 0.87 |
| | 2.7 | 1.00 | 0.85 |
| | 2.8 | 1.00 | 0.92 |
| 1200 | 1 | 1.00 | 1.00 |
| | 1.5 | 1.00 | 1.00 |
| | 1.8 | 1.00 | 1.06 |
| | 2 | 1.00 | 1.18 |
| | 2.1 | 1.00 | 1.35 |

TABLE 2

| | | Curved Corrugation | |
|---|---|---|---|
| | | MONTZ-PAK ™ | MONTZ-PAK ™ |
| | | B1-250MN | B1-250MN |
| | | Surface Texturing: | |
| | | MONTZ ™ | KOCH-GLITSCH ™ |
| Pressure | Fs | DP/TS | DP/TS |
| mmHg | ft/s.(lb/ft³)^{1/2} | mmHg | mmHg |
| 75 | 1 | 1.00 | 0.98 |
| | 1.5 | 1.00 | 1.03 |
| | 2 | 1.00 | 1.00 |
| | 2.5 | 1.00 | 0.92 |
| | 3 | 1.00 | 0.85 |
| | 3.25 | 1.00 | 0.63 |
| 1200 | 1 | 1.00 | 1.00 |
| | 1.5 | 1.00 | 0.92 |
| | 1.8 | 1.00 | 0.76 |
| | 2 | 1.00 | 0.75 |
| | 2.2 | 1.00 | 0.65 |

From the foregoing, it will be seen that this invention is one well adapted to attain all the ends and objectives hereinabove set forth together with other advantages that are inherent to the structure.

It will be understood that certain features and subcombinations are of utility and may be employed without reference to other features and subcombinations. This is contemplated by and is within the scope of the invention.

Since many possible embodiments may be made of the invention without departing from the scope thereof, it is to be understood that all matter herein set forth or shown in the accompanying drawings is to be interpreted as illustrative and not in a limiting sense.

1. A structured packing module comprising:
a plurality of structured packing sheets positioned in an upright, parallel relationship to each other, each structured packing sheet comprising:
opposite faces;
an upper edge and a lower edge;
a lower edge region that is adjacent the lower edge;
a bulk region above the lower edge region;
a plurality of apertures that extend through the structured packing sheet; and
corrugations formed of alternating peaks and valleys that are interconnected by corrugation sidewalls and extend in an inclined direction that forms an inclination angle in relation to the upper edge and/or the lower edge of the structured packing sheet, the structured packing sheets being constructed and arranged such that the corrugations of adjacent ones of the structured packing sheets cross at an angle to each other,
a curve formed in the geometry of the corrugations in the lower edge region such that an inclination angle of the corrugations in relation to the lower edge gradually increases from the bulk region through the lower edge region; and
surface texturing on the structured packing sheets comprising:
a grid of indented and raised structures in the bulk region with each indented structure being separated from some or all of adjacent ones of the indented structures by the raised structures, the raised structures forming rows of peaks and interconnecting saddles; and microchannels that extend along adjacent ones of the indented structures and the interconnecting saddles that are positioned between each of the adjacent ones of the indented structures.

2. The structured packing module of claim 1, wherein the inclination angle of the corrugations at the lower edge is in the range of 65 to 90 degrees.

3. The structured packing module of claim 1, wherein the inclination angle of the corrugations at the lower edge is in the range of 75 to 90 degrees.

4. The structured packing module of claim 3, wherein the indented structures are arranged in parallel rows with the interconnecting saddles of the raised structures connecting adjacent indented structures within each row.

5. The structured packing module of claim 4, wherein each of the peaks of the raised structures is cone-shaped and is formed by a cone-shaped terminus of one of the indented structures on the opposite face of the structured packing sheet.

6. The structured packing module of claim 4, wherein each of the peaks of the raised structures is ridge-shaped and is formed by a ridge-shaped terminus of one of the indented structures on the opposite face of the structured packing sheet.

7. The structured packing module of claim 4, wherein some of the microchannels extend in parallel relationship with the corrugation valleys.

8. The structured packing module of claim 4, including:
an upper edge region that is adjacent the upper edge; and
another curve formed in the geometry of the corrugations in the upper edge region such that an inclination angle of the corrugations in relation to the upper edge gradually increases from the bulk region through the upper edge region.

9. The structured packing module of claim 1, wherein the lower edge region spans 5 to 30 percent, 5 to 25 percent, 5 to 20 percent, 20 to 60 percent, 20 to 50 percent, 25 to 45 percent, or 30 to 40 percent of a distance from the lower edge to the upper edge of the structured packing sheet.

10. The structured packing module of claim 1, wherein the plurality of apertures are uniformly distributed on the structured packing sheets.

11. A structured packing sheet comprising:
opposite faces;
an upper edge and a lower edge;
a lower edge region that is adjacent the lower edge;
a bulk region above the lower edge region;
a plurality of apertures that extend through the structured packing sheet;
corrugations formed of alternating peaks and valleys that are interconnected by corrugation sidewalls and extend in an inclined direction that forms an inclination angle in relation to the upper edge and/or the lower edge of the structured packing sheet;
a curve formed in the geometry of the corrugations in the lower edge region such that an inclination angle of the corrugations in relation to the lower edge gradually increases from the bulk region through the lower edge region; and
surface texturing on the opposite faces comprising:
a grid of indented and raised structures with each indented structure being separated from some or all of adjacent ones of the indented structures by the raised structures, the raised structures forming rows of peaks and interconnecting saddles; and microchannels that extend along adjacent ones of the indented structures and the interconnecting saddles that are positioned between each of the adjacent ones of the indented structures.

12. The structured packing sheet of claim 11, wherein the inclination angle of the corrugations at the lower edge is in the range of 65 to 90 degrees.

13. The structured packing sheet of claim 11, wherein the inclination angle of the corrugations at the lower edge is in the range of 75 to 90 degrees.

14. The structured packing sheet of claim 11, wherein the indented structures are arranged in parallel rows with the interconnecting saddles of the raised structures connecting adjacent indented structures within each row.

15. The structured packing sheet of claim 11, wherein each of the peaks of the raised structures is cone-shaped and is formed by a cone-shaped terminus of one of the indented structures on the opposite face of the structured packing sheet.

16. The structured packing sheet of claim 15, wherein each of the peaks of the raised structures is ridge-shaped and is formed by a ridge-shaped terminus of one of the indented structures on the opposite face of the structured packing sheet.

17. The structured packing sheet of claim 16, wherein some of the microchannels extend in parallel relationship with the corrugation valleys.

18. The structured packing sheet of claim 16, wherein two of the microchannels extend in relation to each other at each indented structure at a crossing angle that is in the range of 50 to 140 degrees.

19. The structured packing sheet of claim 11, wherein the lower edge region spans 5 to 30 percent, 5 to 25 percent, 5 to 20 percent, 20 to 60 percent, 20 to 50 percent, 25 to 45 percent, or 30 to 40 percent of a distance from the lower edge to the upper edge of the structured packing sheet.

20. A structured packing sheet comprising:
opposite faces;
an upper edge and a lower edge;
a lower edge region that is adjacent the lower edge, wherein the lower edge region spans 25 to 45 percent of a distance from the lower edge to the upper edge of the structured packing sheet;
a bulk region above the lower edge region;
a plurality of apertures that extend through the structured packing sheet;
corrugations formed of alternating peaks and valleys that are interconnected by corrugation sidewalls and extend in an inclined direction that forms an inclination angle in relation to the upper edge and/or the lower edge of the structured packing sheet;
a curve formed in the geometry of the corrugations in the lower edge region such that an inclination angle of the corrugations in relation to the lower edge gradually increases from the bulk region through the lower edge region with the inclination angle at the lower edge being in the range of 65 to 90 degrees; and
surface texturing on the opposite faces comprising:
a grid of indented and raised structures with each indented structure being separated from some or all of adjacent ones of the indented structures by the raised structures, the raised structures forming rows of peaks and interconnecting saddles; and microchannels that extend along adjacent ones of the indented structures and the interconnecting saddles that are positioned between each of the adjacent ones of the indented structures, wherein the indented structures are arranged in parallel rows with the interconnecting saddles of the raised structures connecting adjacent indented structures within each row.
